(19) United States
(12) Patent Application Publication
(10) Pub. No.: US 2008/0150929 A1
(43) Pub. Date: Jun. 26, 2008

(54) Plasma display device and driving method thereof

(76) Inventors: Byunggwon Cho, Yongin-si (KR); Jeonghoon Kim, Yongin-si (KR)

Correspondence Address: ROBERT E. BUSHNELL, 1522 K STREET NW, SUITE 300, WASHINGTON, DC, 20005-1202, US

(21) Appl. No.: 11/987,999

(22) Filed: Dec. 6, 2007

(30) Foreign Application Priority Data
Dec. 21, 2006 (KR) 10-2006-0131960

(51) Int. Cl. G06F 3/038

(52) U.S. Cl. 345/211

(57) ABSTRACT

Disclosed is a plasma display device and a driving method thereof that can enhance a contrast ration of the screen with high load factor by controlling black luminance as adjusting rising section of a reset period according to load factor of a displayed screen. The plasma display device includes: a Plasma Display Panel (PDP) including a plurality of a scan electrodes, a plurality of sustain electrodes and a plurality of address electrodes; a scan electrode driver, connected to the PDP, supplying a rising ramp pulse to the scan electrode for a reset period; a controller, connected to the scan electrode driver, controlling an supplying time of the rising ramp supplied to the scan electrode according to the load factor of the screen.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on the 21^{st} of December 2006 and there duly assigned Serial No. 2006-0131960.

### BACKGROUND OF THE INVENTION

1. Field of the Invention

The present invention relates to a plasma display device, and more particularly, the present invention relates to a plasma display device and a driving method thereof, that can enhance a contrast ratio of a screen having a high load factor by adjusting a rise time of a reset period according to load factor of the screen to control the black luminance.

2. Description of the Related Art

A Plasma Display Panel (PDP) is a flat display device displaying characters or images using a plasma generated by a gas discharge. A plurality of row electrodes and a plurality of column electrodes are formed on a display panel of the plasma display device. Discharge cells are formed at points where the row electrodes and column electrodes intersect. A gray scale of the image is displayed by adjusting a discharge state of the respective discharge cells.

Generally, the PDP displays gray scales by dividing one frame supplied to the display panel into a plurality of subfields having each weight value and then controlling them by using a time division method.

One frame is divided into several subfields (e.g. 8 subfields with different emissions) and displays 256 gray scales. In other words, when the image is displayed with 256 gray scales, one frame period (16.67 ms) corresponding to 1/60 of a second is divided into 8 subfields. Furthermore, 8 subfields are respectively divided into a reset period, an address period, and a sustain period.

For the reset period, each cell is initialized to freely perform an address operation. For the address period, on-cells of a plurality of cells are selected by an address discharge. For the sustain period, a real image is displayed by discharging the discharge cells selected in the address period using a sustain pulse that alternatively has a high level voltage and a low level voltage for a predetermined time.

However, in a related art plasma display device displaying the image by using the same number of sustain pulses, the luminance of light emitting cells displayed by the same number of sustain pulses is varied according to a screen load factor (i.e., area of the light emitting cells emitting light due to the sustain pulses for all cells). In other words, when the screen load factor is decreased, the luminance of the light emitting cells displayed by the sustain pulses is increased, while when the screen load factor is increased, the luminance of the light emitting cells displayed by the sustain pulse is decreased.

Accordingly, when the screen load factor is low, the difference between the brightest white luminance and the darkest black luminance is large. Herein, the white luminance is the brightness of the light that is generated by the sustain discharge, and the black luminance is the brightness of the light that is generated by the reset discharge. As described above, a contrast ratio of the display panel is high because the difference between the brightest white luminance and the darkest black luminance is large. On the other hand, when the load factor of the screen is high, there is a problem in that the contrast factor of the display panel becomes low because the difference between the brightest white luminance and the darkest black luminance is small.

Accordingly, a related art plasma display device has been required to increase the difference between the brightest white luminance and the darkest black luminance when the screen has the high load factor.

### SUMMARY OF THE INVENTION

An object of the present invention is to provide a plasma display device and a driving method thereof that can enhance a contrast ratio of a screen having a high load factor by adjusting a rise time of a reset period according to load factor of the screen to control the black luminance.

According to one aspect of the present invention, a plasma display device is provided, the plasma device including: a Plasma Display Panel (PDP) including a plurality of scan electrodes, a plurality of sustain electrodes, and a plurality of address electrodes a scan electrode driver, connected to the PDP, to supply a rising ramp pulse to the scan electrode for a reset period; and a controller, connected to the scan electrode driver, to control a supplying time of the rising ramp pulse supplied to the scan electrode according to a screen load factor.

The controller may include: load factor calculator to determine the screen load factor due to an external image signal; memory to store a lookup table including supplying time information of the rising ramp pulse that corresponds to the screen load factor determined by the load factor calculator; and rising ramp pulse width controller, connected between the load factor calculator and the memory, to provide the supplying time information of the rising ramp pulse, corresponding to the determined screen load factor, to the scan electrode driver.

The lookup table may include: setting the supplying time of the ramp pulse to a predetermined reference supplying time (100%) in response to the screen load factor being in a range of 0%˜50%; and setting the supplying time of the ramp pulse to be shorter than the reference supplying time in response to the screen load factor exceeding 50%,

The lookup table may set the supplying time of the rising ramp pulse to be gradually reduced by an inverse proportion to the screen load factor in response to the screen load factor exceeding 50%.

The controller may reduce reset discharge generating between the electrodes by reducing the supplying time of the rising ramp pulse by the lookup table in response to the screen load factor exceeding 50%.

A slope of the rising ramp pulse may be maintained at a constant value.

A maximum voltage of the rising ramp pulse may be in proportion to the supplying time of the rising ramp pulse.

The plasma display device may further include: an address electrode driver, connected between the PDP and the controller, to supply a display data signal to the address electrode under the control of the controller; and a sustain electrode driver, connected between the PDP and the controller, to supply a sustain pulse to the sustain electrode under the control of the controller.

According to another aspect of the present invention, a method of driving a plasma display device including a Plasma Display Panel (PDP) having a discharge cell defined by a plurality of scan electrodes, a plurality of sustain electrodes, and a plurality of address electrodes is driven by a driving waveform having a reset period, an address period, and a sustain period in each of a plurality of sub-fields is provided, the method including: determining a screen load factor; determining a supplying time of a rising ramp pulse, supplied to the scan electrode during the reset period, according to the determined screen load factor; and supplying the rising ramp pulse to the scan electrode during the reset period, according to information on the determined supplying time of the rising ramp pulse.

Determining a screen load factor may include: calculating a luminance cell area to emit light during the sustain period for all of the discharge cells of the PDP by using a load factor calculator.

During determining a supplying time of a rising ramp pulse, supplied to the scan electrode during the reset period, according to the determined screen load factor, a rising ramp pulse width controller connected to the load factor calculator may determine the supplying time of the rising ramp pulse by a lookup table storing the supplying time of the rising ramp pulse data according to the screen load factor.

The lookup table may set the supplying time of the rising ramp pulse to a predetermined reference supplying time (100%) according to the screen load factor being in a range of 0%˜50%, and the lookup table may set the supplying time of the rising ramp pulse to be shorter than the reference supplying time according to the screen load factor exceeds 50%.

The lookup table may set the supplying time of the rising ramp pulse to be gradually reduced by an inverse proportion to the screen load factor when the screen load factor exceeds 50%.

The controller may reduce a reset discharge generated between the electrodes by reducing the supplying time of the rising ramp pulse by the lookup table when the screen load factor exceeds 50%.

The scan electrode driver may supply the rising ramp pulse to the scan electrodes, in response to the rising ramp pulse continuously rising with a constant slope from a first voltage level to a second voltage level for a rise time of the reset period, and the scan electrode driver may supply the falling ramp pulse to the scan electrode, in response to the falling ramp pulse continuously falling with a constant slope from the first voltage level to a third voltage level for a fall time of the reset period.

The driving method may further include: supplying a display data signal to the address electrode by an address driver connected to the PDP; and supplying a sustain pulse to the sustain electrode by a sustain driver connected to the PDP.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display device according to one exemplary embodiment of the present invention.

FIG. 2 is a detailed block diagram of the controller 200 of FIG. 1.

FIG. 3 is a diagram of a lookup table included in the memory 250 of FIG. 2.

FIG. 4 is a timing chart of a driving method driven by configuring a unit frame into a plurality of subfields to drive the PDP of the plasma display device of FIG. 1.

FIG. 5 is a waveform diagram of an example of a driving waveform to drive the PDP of the plasma display device of FIG. 1.

FIG. 6 is a flowchart of a process that the supplying time of the rising ramp pulse supplied the Y electrode in the reset period, among the driving waveforms of FIG. 5, is controlled by the controller.

FIG. 7A is a waveform diagram of a driving waveform supplied to the electrode in the reset period when the screen load factor of the PDP of FIG. 1 is 0 to 50%.

FIG. 7B is a waveform diagram of a driving waveform supplied the electrode when the screen load factor of the PDP of FIG. 1 is 100%.

### DETAILED DESCRIPTION OF THE INVENTION

Hereinafter, exemplary embodiments of the present invention are described in detail with reference to the accompanying drawing. The aspects and features of the present invention and methods for achieving the aspects and features of the present invention will be apparent by referring to the embodiments described in detail with reference to the accompanying drawings. However, the present invention is not limited to the embodiments disclosed hereinafter, but can be implemented in diverse forms. The matters defined in the description, such as the detailed construction and elements, are merely specific details provided to assist those of ordinary skill in the art in a comprehensive understanding of the present invention, and the present invention is only defined within the scope of the appended claims. In the entire description of the present invention, the same drawing reference numerals are used for the same elements across various figures.

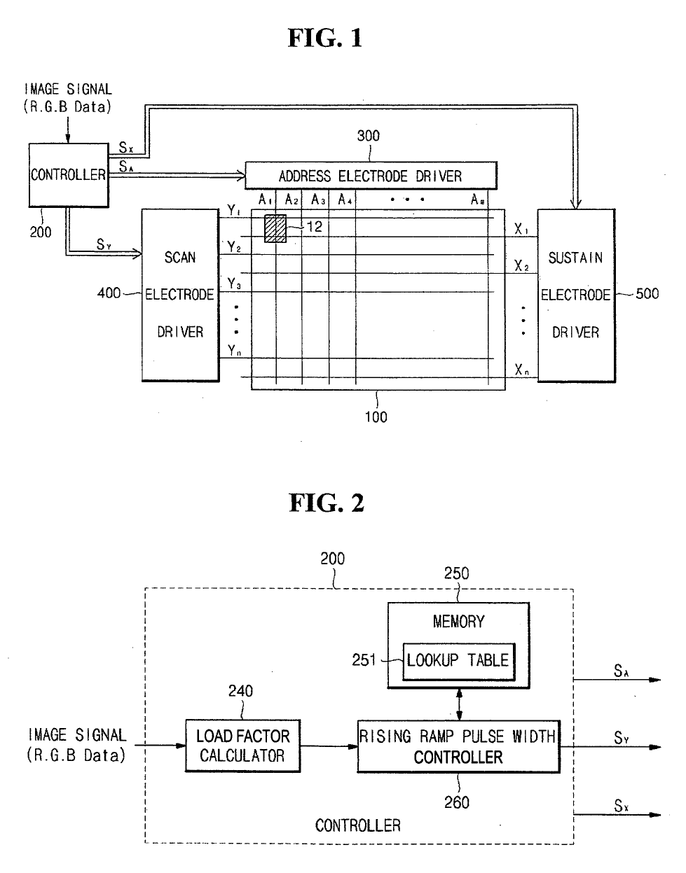

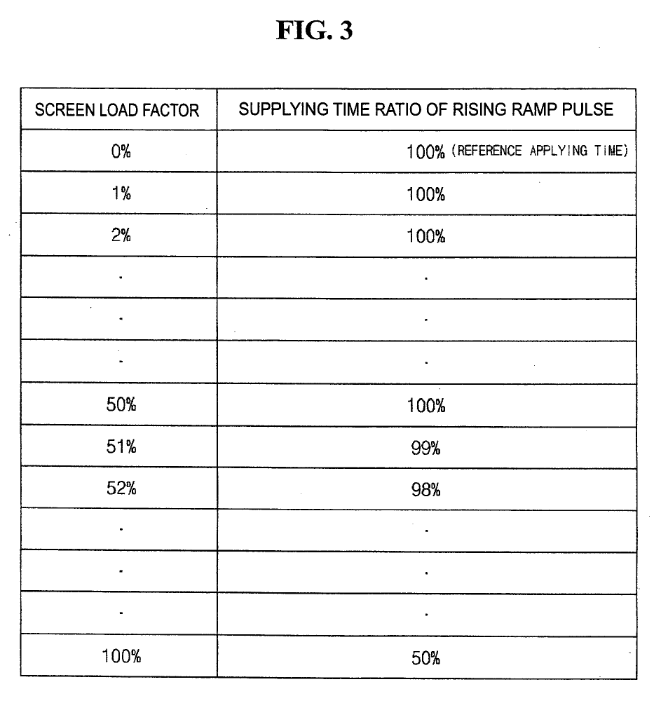

FIG. 1 is a block diagram of a plasma display device according to one exemplary embodiment of the present invention, and FIG. 2 is a detailed block diagram of the controller 200 of FIG. 1.

Referring to FIG. 1, the plasma display device includes a plasma Plasma Display Panel (PDP) 100, a controller 200, an address electrode driver 300, a scan electrode driver 400, and a sustain electrode driver 500.

The plasma display device 100 includes a plurality of address electrodes (hereafter, referred to as “A electrodes”) (A₁˜Aₘ) that extend in a column direction, a plurality of sustain electrodes (hereafter, referred to as “X electrodes”) (X₁˜Xₙ) that extend in a row direction with a plurality of scan electrodes (hereafter, referred to as “Y electrodes”) (Y₁˜Yₙ). Generally, the X electrodes (X₁˜Xₙ) are formed to correspond to the Y electrodes (Y₁˜Yₙ). The X electrodes and Y electrodes perform a display operation to display an image during a sustain period. The X electrodes and Y electrodes are orthogonal to the A electrodes (A₁˜Aₘ). A discharge cell is formed by a discharge space that is at an intersection point of the A electrodes (A₁˜Aₘ) and X and Y electrodes (X₁˜Xₙ, Y₁˜Yₙ). This structure of the plasma PDP 100 is one example of the present invention. Panels of other structures that can operate with the following driving waveforms may also be applied to the present invention.

A controller 200 receives an external image signal (R, G, B Data) and a sync signal, and then outputs an address electrode driving control signal (S_{A}), a scan electrode driving control signal (S_{Y}), and a sustain electrode driving control signal (S_{X}). The controller 200 is driven by dividing one frame into a plurality of subfields. Each respective subfield includes a reset period, an address period, and a sustain period. The controller 200 determines a screen load factor of the PDP 100 by the received external image signal (R, G, B Data), and then outputs the scan electrode driving control signal (S_{Y}) according to the determined screen load factor.

The address electrode driver 300 processes the address electrode driving control signal (S_{A}) of the driving control signals (S_{A}, S_{Y}, S_{X}) to generate a display data signal, and then supplies the generated display data signal to the A electrodes.

The scan electrode driver 400 processes the scan electrode driving control signal (S_{Y}) of the driving control signals (S_{A}, S_{Y}, S_{X}), and then supplies the generated display data signal to the Y electrodes.

The sustain electrode driver 500 processes the sustain electrode drive control signal (S_{X}) of the drive control signals (S_{A}, S_{Y}, S_{X}) from the controller 200, and then supplies the generated sustain pulse to the X electrodes.

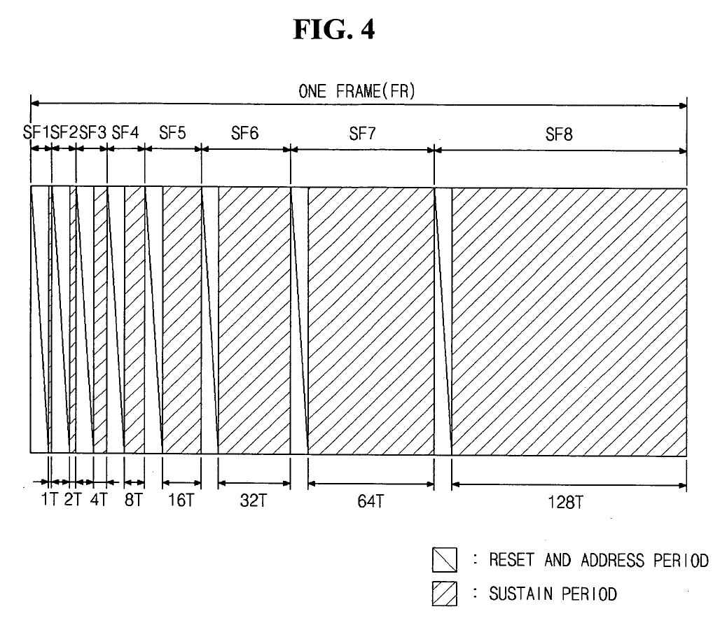

FIG. 2 is a detailed block diagram of the controller 200 of FIG. 1, and FIG. 3 is a diagram of a lookup table included in a memory 250 of FIG. 2.

Referring to FIG. 2, the controller 200 includes a load factor calculator 240, a memory 250, and a rising ramp pulse width controller 260.

The load factor calculator 240 calculates a screen load factor of the PDP 100 according to the external image signal. The screen load factor is an emission area ratio of a light emitting cell (i.e., a light emitting cell emitting light due to a sustain discharge generated between the X electrode and Y electrode for the sustain period) to all cells of one screen. For example, when the screen load factor is 100%, then all of the cells of one screen emit light.

The memory 250 stores a lookup table 251 including information on a supplying time of the rising ramp pulse that corresponds to the screen load factor. The supplying time of the rising ramp pulse is a time for supplying the rising ramp pulse to the Y electrode for the rise time of the reset period.

The rising ramp pulse width controller 260 receives the screen load factor of the PDP 100, which is calculated from the load factor calculator 240, and then determines the supplying time of a rising ramp pulse by using the lookup table 251 of the memory 250. The rising ramp pulse width controller 260 outputs the scan electrode driving control signal (S_{Y}) including information on the determined supplying time of the rising ramp pulse. The scan electrode driver 400 in FIG. 1 supplies the rising ramp pulse to the Y electrode for the rise time of the reset period according to the scan electrode driving control signal (S_{Y}) including information on the supply time of the rising ramp pulse.

FIG. 3 is a diagram of information included in the lookup table 251 of FIG. 2. The screen load factor represents the area of the light emitting cells emitting light due to the sustain discharge for the sustain period among all of the cells of the screen. A supplying time of 100% of the rising ramp pulse represents the reference supplying time of the predetermined rising ramp pulse.

In the lookup table 251, the supplying time of the rising ramp pulse is 100% when the screen load factor is 0 to 50%. The supplying time of the rising ramp pulse is reduced from 99% of the reference time (100%) to 50% as the screen load factor is increased from 51 to 100%. This means that although the same sustain pulse is supplied to the screen, the luminance of the cell emitting light is varied according to the screen load factor.

In other words, when the screen load factor is low, the contrast ratio of the white to black luminance is high. Accordingly, the supplying time of the rising ramp pulse is set to the predetermined reference supplying time (100%).

On the other hand, when the screen load factor is high, the contrast ratio of the white to black luminance is low. Therefore, the supplying time of the rising ramp pulse is set to a shorter time than the reference supplying time (100%). For example, when the screen load factor exceeds 50%, the supplying time of the rising ramp pulse is set to be gradually reduced by an inverse proportion to the screen load factor.

Accordingly, when the screen load factor is increased by exceeding 50%, the supplying time of the rising ramp pulse is reduced, and the reset discharge generated for the rise time of the reset period is reduced, thereby allowing the black luminance generated by the reset discharge to be reduced. Accordingly, the contrast ratio can be increased by increasing the difference between the white luminance and the black luminance. When the screen load factor exceeds 50%, the supplying time of the rising ramp pulse is decreased, because the user can perceive the contrast lowering. The supplying time of the rising ramp pulse can be reduced to up to 50% of a reference supplying time. If the supplying time of the rising ramp pulse is reduced to be above 51% of the reference supplying time (100%), wall charges required for the address discharge can not be formed fully. Therefore, a low discharge can be generated in the address period.

As described above, the controller 200 including the load factor calculator 240, the memory 250 and the rising ramp pulse width controller 260 is connected to the scan electrode driver 300 so as to control the time for supplying the rising ramp pulse to the Y electrode, thereby controlling the reset discharge generated among the electrodes for the reset period. Accordingly, when the white luminance is low because the screen load factor exceeds 50%, the controller 200 can increase the contrast ratio between the white and black luminance by reducing the black luminance due to the reset discharge.

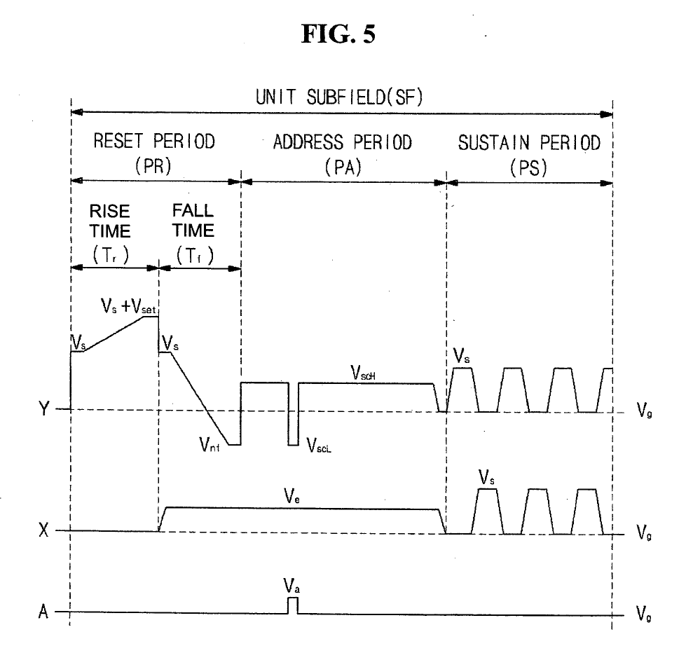

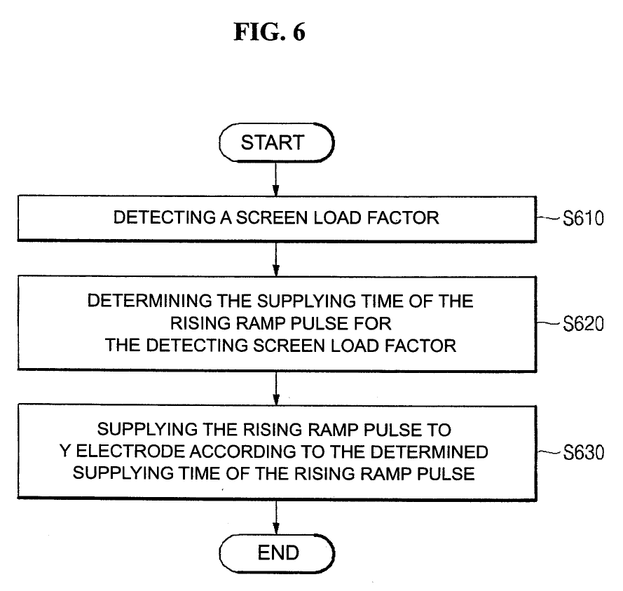

FIG. 4 is a timing chart of a driving method driven by configuring a unit frame into a plurality of subfields to drive the PDP of the plasma display device of FIG. 1, and FIG. 5 is a waveform diagram of an example of a driving waveform to drive the PDP of the plasma display device of FIG. 1.

Referring to FIG. 4, to implement a time division gray scale display, the PDP of the plasma display device is driven by processing an inputted external image signal, classifying the image signal into one frame unit, and dividing the one frame unit into 8 to 11 subfields having different numbers of emissions. In the present invention, the one frame is divided into 8 subfields (SF1˜SF8). Furthermore, the respective subfields (SF1˜SF8) are divided into a reset period, an address period, and a sustain period.

The luminance of the PDP 100 is in proportional to the sustain period time. In the one frame, the time of the sustain period is 255 T (T indicates a unit time). The sustain period of n subfield (SFn) (n indicates positive integer) is set to a time corresponding to 2ⁿ respectively. Accordingly, if the subfields to be displayed of 8 subfields are selected properly, 256 gray scale displays may be displayed including the 0 gray scale that is not displayed on any subfield.

Referring to FIG. 5, in the driving waveform to drive the PDP 100 of the plasma display device, a reset period (PR) of a subfield (SF) may include a rise time (Tᵣ) and a fall time (T_{f}). During the rise time (Tᵣ), a voltage of a rising ramp pulse waveform is supplied to the Y electrodes (Y₁˜Yₙ). The voltage of the rising ramp pulse waveform is continuously increased from the first voltage (V_{S}), e.g., 200 volts to the second voltage (V_{S}+Vₛₑₜ), e.g., 355 volts that is higher than the first voltage (V_{S}) by as much as a constant voltage (V_{S}). A ground voltage (V_{g}) is supplied to the X electrodes (X₁˜Xₙ) and the address electrodes (A₁˜Aₘ). Accordingly, a weak discharge is generated between the Y electrodes (Y₁˜Yₙ) and X electrodes (X₁˜Xₙ) while a weaker discharge is generated between the Y electrodes (Y₁˜Yₙ) and A electrodes (A₁˜Aₘ).

Next, during the fall time (T_{f}), a voltage of a falling ramp pulse waveform is supplied to Y electrodes (Y₁˜Yₙ), the voltage falling continuously from the first voltage (V_{S}) to a third voltage (V_{nf}) (e.g. up to −200 volts). The voltage supplied to the X electrodes (X₁˜Xₙ) is maintained at a fourth voltage (Vₑ), and the voltage supplied to the A electrodes (A₁˜Aₘ) is maintained at the ground voltage (V_{g}).

Next, during the address period (PA), the display data signal of the address pulse is supplied to the A electrodes (A₁˜Aₘ), and a scan low voltage (V_{scL}) (e. g., a scan signal of a scan pulse of −200 volts) is sequentially supplied to the Y electrodes (Y₁˜Yₙ) that are biased to a scan high voltage voltage (V_{scH}) (e. g., 120 volts) which is lower than the first voltage (V_{S}), and thus, smooth addressing may be performed. In order to have the scan low voltage (V_{scL}) being of a lower voltage value than the third voltage (V_{nf}), the third voltage (V_{nf}) can be set to −188 volts and the scan low voltage (V_{scL}) can be set to −200 volts.

If a discharge cell is selected, a positive address voltage (Vₐ) is supplied to the respective A electrodes (A₁˜Aₘ) as a display data signal. If not, a ground voltage (V_{g}) is supplied to the respective A electrodes (A₁˜Aₘ) as the display data signal. Accordingly, if the display data signal of the positive address voltage (Vₐ) is supplied while the scan pulse of the scan low voltage (V_{scL}) is supplied, wall charges are formed by the address discharge in the corresponding discharge cell. If not, the wall charges are not formed in the discharge cell. Furthermore, the fourth voltage (Vₑ) is supplied to the X electrode (X₁˜Xₙ) for more accurate and efficient address discharge.

Next, during the sustain period (PS), the sustain pulse of the first voltage (V_{S}) is alternately supplied to the Y electrodes (Y₁˜Yₙ) and X electrodes (X₁˜Xₙ), and thus, the sustain discharge is generated in the discharge cells where the wall charges had been formed during the address period (PA).

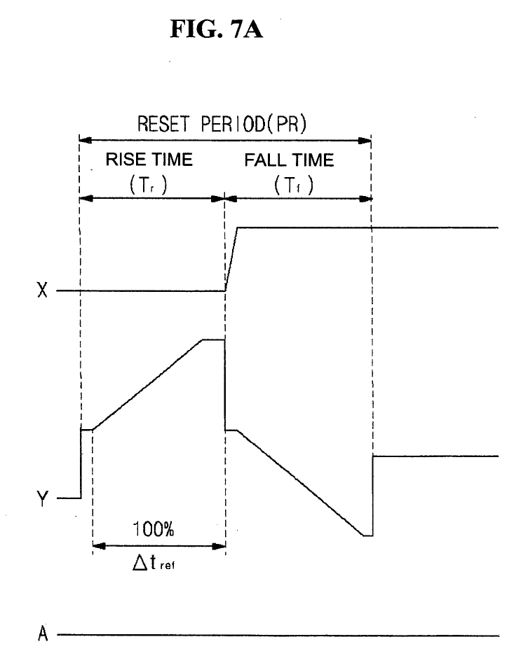

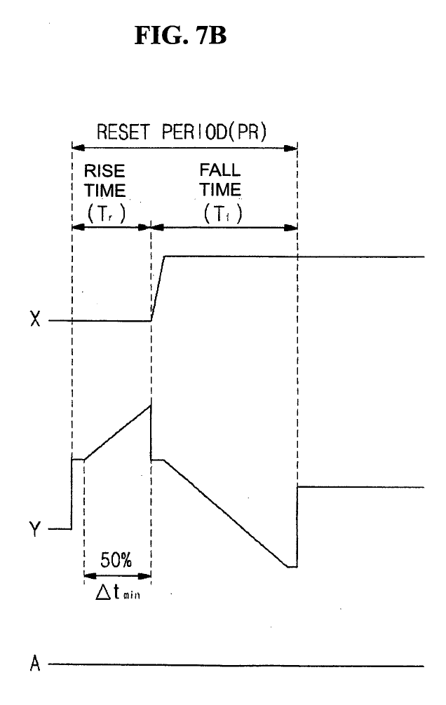

FIG. 6 is a flowchart of a process in which the supplying time of the rising ramp pulse supplied to the Y electrode during the reset period is controlled by the controller 200. FIG. 7A is a driving waveform diagram supplied to the electrode during the reset period when the screen load factor of the PDP 100 of FIG. 1 is 0 to 50%, and FIG. 7B is a driving waveform diagram supplied to the Y electrode when the screen load factor of the PDP 100 of FIG. 1 is 100%.

Referring to FIG. 6, in step S610, the load factor calculator 240 receives an external image signal, and then calculates the screen load factor of the PDP 100 by the received image signal to determine the screen load factor.

The screen load factor is obtained by calculating the emission area of a light emitting cell among all of the cells of one screen. The light emitting cell is a light emitting cell emitting due to the sustain discharge generated between the X electrode and Y electrode during the sustain period.

The rising ramp pulse width controller 260 connected to the load factor calculator 240 receives information on the determined screen load factor.

In step S620, the rising ramp pulse width controller 260 determines the supplying time of the rising ramp pulse that corresponds to the screen load factor received from the load factor calculator 240, by information of the lookup table 251 stored in the memory 250.

In other words, when the rising ramp pulse width controller 260 determines that the screen load factor is 0 to 50%, a predetermined reference supplying time (Δt_{ref}=100%) is, as shown in FIG. 7A, determined by the lookup table 251 of FIG. 3. A predetermined reference supplying time (Δt_{ref}=100%) is the supplying time ofthe rising ramp pulse that corresponds to the screen load factor of 0 to 50%. Because the contrast ratio of the white to black luminance is high when the screen load factor is 0 to 50%, the supplying time of the rising ramp pulse supplied to the Y electrode for rise time (Tᵣ) of the reset period (PR) is determined to be the predetermined supplying time (Δt_{ref}=100%) of the rising ramp pulse. The predetermined reference supplying time(Δt_{ref}) may be changed by panel size, and thus, the predetermined reference supplying time(Δt_{ref}) is represented as a ratio.

When the rising ramp pulse width controller 260 determines that the screen load factor is above 50%, the supplying time of the rising ramp pulse that is supplied to the Y electrode for rise time (Tᵣ) of the reset period (PR) by the lookup table 251 of FIG. 3 is determined to be the supplying time of the rising ramp shorter than the predetermined reference supplying time (Δt_{ref}=100%). For example, as shown in FIG. 7B, when the screen load factor is 100%, i.e., when all of the cells are emitting light due to the sustain discharge, the rising ramp pulse width controller 260 determines that the rising ramp pulse time (Δtₘᵢₙ=50%) that corresponds to the screen load factor of 100% by the lookup table 251 of FIG. 4

In step (S630), the rising ramp pulse width controller 260 provides information on the determined supplying time of the rising ramp pulse to a scan electrode driver 400 connected to the rising ramp pulse width controller 260. The scan electrode driver 400 supplies the rising ramp pulse to the Y electrode for the rise time (Tᵣ) of the reset period (PR) according to the supplying time of the rising ramp pulse information received from the rising ramp pulse width controller 260.

For example, as shown in FIG. 7A, when the screen load factor is 0 to 50%, the rising ramp pulse supplied to the Y electrode is equal the predetermined supplying time (Δt_{ref}=100%) of the rising ramp pulse for the rise time (Tᵣ) of the reset period (PR). As shown in FIG. 7B, when the screen load factor exceeds 50%, e.g., when the screen load factor is 100%, the rising ramp pulse is supplied to the Y electrode during 50% of the predetermined time (Δt_{ref}) for the rise time (Tᵣ) of the reset period (PR).

As described above, the supplying time of the rising ramp pulse supplied to the Y electrode for the rise time (Tᵣ) of the reset period (PR) when the screen load factor is high is reduced as compared with that of the rising ramp when the screen load factor is low. Accordingly, the reset discharge generated during the reset period (PR) when the screen load factor is high is relatively reduced as compared with the reset discharge when the screen load factor is low. Thus, when the screen load factor is high, the amount of emission due to the reset discharge is reduced as compared with that when the screen load factor is low, thereby reducing the black luminance.

The controller 200 controls only the supplying time of the rising ramp pulse supplied to the Y electrode for the rise time (Tᵣ) of the reset period (PR). Thus, the rising slope of the rising ramp pulse is not changed, and is maintained at the predetermined slope. Accordingly, the maximum voltage of the rising ramp pulse is in proportion to the supplying time of the rising ramp pulse.

As described above, the controller 200 controls the supplying time of the rising ramp pulse supplied to the Y electrode in the rise time (Tᵣ) of the reset period (PR) according to the screen load factor, thereby controlling the reset discharge generated for the rise time (Tᵣ) of the reset period (PR). In other words, the supplying time of the rising ramp supplied to the Y electrode for the rise time (Tᵣ) of the reset period (PR) when the screen load factor is high is reduced as compared to that of the rising ramp when the screen load factor is low. As result thereof, an electric potential difference between the Y electrode and the X electrode is relatively reduced as compared to when the screen load factor is low.

Accordingly, the reset discharge when the screen load factor is high is reduced more than when the screen load factor is low. Thus, the amount of emission due to the reset discharge when the screen load factor is high is reduced as compared when the screen load factor is low, thereby reducing the black luminance. Consequently, when the screen load factor is high, the contrast ratio can be improved by increasing the difference between the black and the white luminance, i.e., the light emitted due to the sustain discharge.

As described above, the plasma display device and driving method thereof according to the present invention includes the controller controlling the supplying time of the rising ramp pulse according to the screen load factor, thereby controlling the black luminance according to the screen load factor. Therefore, it improves the contrast ratio of the screen having the high load factor.

Furthermore, the plasma display device and driving method thereof according to the present invention can ensure the sustain period as much as the reset period reduced by the increasing screen load factor.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as being limitations of the present invention.

What is claimed is:

1. A plasma display device, comprising:
a Plasma Display Panel (PDP) including a plurality of scan electrodes, a plurality of sustain electrodes, and a plurality of address electrodes;
a scan electrode driver, connected to the PDP, to supply a rising ramp pulse to the scan electrode for a reset period; and
a controller, connected to the scan electrode driver, to control a supplying time of the rising ramp pulse supplied to the scan electrode according to a screen load factor.

2. The plasma display device of claim 1, wherein the controller comprises:
a load factor calculator to determine the screen load factor due to an external image signal;
a memory to store a lookup table including supplying time information of the rising ramp pulse that corresponds to the screen load factor determined by the load factor calculator; and
a rising ramp pulse width controller, connected between the load factor calculator and the memory, to provide the supplying time information of the rising ramp pulse, corresponding to the determined screen load factor, to the scan electrode driver.

3. The plasma display device of claim 2, wherein the lookup table:
sets the supplying time of the ramp pulse to a predetermined reference supplying time (100%) in response to the screen load factor being in a range of 0%˜50%; and
sets the supplying time of the ramp pulse to be shorter than the reference supplying time in response to the screen load factor exceeding 50%,

4. The plasma display device of claim 3, wherein the lookup table sets the supplying time of the rising ramp pulse to be gradually reduced by an inverse proportion to the screen load factor in response to the screen load factor exceeding 50%.

5. The plasma display device of claim 3, wherein the controller reduces reset discharge generating between the electrodes by reducing the supplying time of the rising ramp pulse by the lookup table in response to the screen load factor exceeding 50%.

6. The plasma display device of claim 1, wherein a slope of the rising ramp pulse is maintained at a constant value.

7. The plasma display device of claim 6, wherein a maximum voltage of the rising ramp pulse is in proportion to the supplying time of the rising ramp pulse.

8. The plasma display device of claim 1, further comprising:
an address electrode driver, connected between the PDP and the controller, to supply a display data signal to the address electrode under the control of the controller; and
a sustain electrode driver, connected between the PDP and the controller, to supply a sustain pulse to the sustain electrode under the control of the controller.

9. A method of driving a plasma display device including a Plasma Display Panel (PDP) having a discharge cell defined by a plurality of scan electrodes, a plurality of sustain electrodes, and a plurality of address electrodes is driven by a driving waveform having a reset period, an address period, and a sustain period in each of a plurality of sub-fields, the method comprising:
determining a screen load factor;
determining a supplying time of a rising ramp pulse, supplied to the scan electrode during the reset period, according to the determined screen load factor; and
supplying the rising ramp pulse to the scan electrode during the reset period, according to information on the determined supplying time of the rising ramp pulse.

10. The driving method of claim 9, wherein determining a screen load factor comprises:
calculating a luminance cell area to emit light during the sustain period for all of the discharge cells of the PDP by using a load factor calculator.

11. The driving method of claim 10, wherein during determining a supplying time of a rising ramp pulse, supplied to the scan electrode during the reset period, according to the determined screen load factor, a rising ramp pulse width controller connected to the load factor calculator determines the supplying time of the rising ramp pulse by a lookup table storing the supplying time of the rising ramp pulse data according to the screen load factor.

12. The driving method of claim 11, wherein the lookup table sets the supplying time of the rising ramp pulse to a predetermined reference supplying time (100%) according to the screen load factor being in a range of 0%˜50%, and the lookup table sets the supplying time of the rising ramp pulse to be shorter than the reference supplying time according to the screen load factor exceeds 50%.

13. The driving method of claim 12, wherein the lookup table sets the supplying time of the rising ramp pulse to be gradually reduced by an inverse proportion to the screen load factor when the screen load factor exceeds 50%.

14. The driving method of claim 13, wherein the controller reduces a reset discharge generated between the electrodes by reducing the supplying time of the rising ramp pulse by the lookup table when the screen load factor exceeds 50%.

15. The driving method of claim 9, wherein the scan electrode driver supplies the rising ramp pulse to the scan electrodes, in response to the rising ramp pulse continuously rising with a constant slope from a first voltage level to a second voltage level for a rise time of the reset period, and wherein the scan electrode driver supplies the falling ramp pulse to the scan electrode, in response to the falling ramp pulse continuously falling with a constant slope from the first voltage level to a third voltage level for a fall time of the reset period.

16. The driving method of claim 9, further comprising:
supplying a display data signal to the address electrode by an address driver connected to the PDP; and
supplying a sustain pulse to the sustain electrode by a sustain driver connected to the PDP.
